(19) United States
(12) Patent Application Publication
(10) Pub. No.: US 2008/0065254 A1
(43) Pub. Date: Mar. 13, 2008

(54) Methods for Machining Process Parameter Estimation and Systems Thereof

(75) Inventors: Brian P. Mann, Gainesville, FL (US); Nitin K. Garg, Gainesville, FL (US); Philip V. Bayly, St. Louis, MO (US); John K. Schueller, Gainesville, FL (US); Tony L. Schmitz, Gainesville, FL (US)

Correspondence Address: AKERMAN SENTERFITT, P.O. BOX 3188, WEST PALM BEACH, FL, 33402-3188, US

(73) Assignee: University of Florida Research Foundation, Inc., Gainesville, FL (US)

(21) Appl. No.: 11/577,429

(22) PCT Filed: Nov. 1, 2005
(86) PCT No.: PCT/US05/39588

§ 371 Date: Nov. 15, 2007

Related U.S. Application Data
(60) Provisional application No. 60/623,931, filed on Nov. 1, 2004.

(51) Int. Cl. G06F 19/00

(52) U.S. Cl. 700/159

(57) ABSTRACT

A method for directly determining model parameters for a machining process that includes the steps of providing a system having a machining tool and a workpiece, and machining the workpiece using the machining tool, where the machining induces motions in the machining tool or the workpiece. The motions are then measured and used to estimate system characteristic multipliers (eigenvalues). A set of process model parameters is obtained by relating the eigenvalues to the results of an analytical method, a theoretical model or both.

### FIELD OF THE INVENTION

The invention relates to methods of directly determining cutting model parameters from measurements of motion induced in the workpiece or machining tool during cutting.

### BACKGROUND

One of the most fundamental tasks for part production is the selection of machining process parameters by major manufacturers, such as for airplanes and automobiles. Improper selection of machining process parameters can greatly lower productivity, increase part cost, and reduce part quality and accuracy. Therefore, methods that facilitate the proper selection of machining process parameters can have a profound impact upon the productivity and success of a manufacturer, as well as the performance of the manufactured product.

Currently, known methods for predicting the vibration behavior of a machining process require at least two steps. In a first step, modal parameters (or frequency response functions) are first found. The modal parameters or frequency response function for a given tool/tool holder/spindle is commonly obtained through experimental vibration testing from impact testing or frequency sweep testing. A separate approach can analytically predict the frequency response function, but still suffers because independent vibration tests for the tool/tool holder/spindle are still required.

In the second required test, cutting force model parameters for the cutting tool/workpiece combination are then determined experimentally. A current method for obtaining cutting force model parameters is to measure the cutting forces with a load cell while the cutting process is proceeding. Once the experimentally identified cutting force parameters are obtained, several methods can be used to determine the vibration characteristics for the machining process. Using the vibrational characteristics together with the modal parameters, cutting model parameters are finally determined.

The primary difficulty with current methods is that it is impractical for manufacturers to perform individual vibration tests on every single cutting too/tool holder/and machine to determine the modal parameters (or frequency response functions) or to measure the cutting forces (model parameters) for every tool geometry/workpiece combination. Therefore, the benefits of stability and surface location error predictions are not generally captured by the tool manufacturing industry. In the instance a manufacturer does perform individual vibration tests and separate cutting force tests, it becomes both expensive to have individuals perform the testing and use the necessary equipment and time consuming.

What is needed is a method for directly estimating model parameters from vibration measurements during the cutting process. Such a method would remove the need for generally impractical conventional methods of parameter estimation and would enable improved decision making information (stability, accuracy, and surface quality) to improve productivity, efficiency, and accuracy of the cutting process.

### SUMMARY

A method for directly determining model parameters for a machining process includes the steps of providing a system having a machining tool and a workpiece, and machining the workpiece using the machining tool, wherein the machining induces motions in the machining tool or the workpiece. The motions are then measured. System characteristic multipliers (eigenvalues) are estimated from the motions. The eigenvalues are then related to results of at least one an analytical method or theoretical model to obtain a set of process model parameters. The model parameters can be used for stability, accuracy (surface location error) and surface quality predictions. The motions are generally induced exclusively by the machining step, thus, no external excitation is required.

The analytical method can comprises a semi-analytical approach. The motions can be obtained from sensing acceleration, velocity or displacement in the workpiece. The motions can be obtained during steady-state motion of the system, or during initial transients of the system.

The method can include the step of estimating model parameters of the machining tool directly from motions at the end of the machining step. For instance, free vibrations occur at the end of the cutting process (e.g. after the tool leaves the workpiece). A structural mathematical model for the system can be obtained using a variety of modal parameter estimations methods on this portion of the signal. The example described herein uses a single degree of freedom model to illustrate this process, but the results are not limited to single degree of freedom systems.

The method can include the step of predicting stability (chatter) of the system using the model parameters. Once model parameters have been obtained using the empirical approach, the process described as the semi-analytical method can also provide stability predictions. The method can also comprise the step of determining surface location error using a semi-analytic method.

### BRIEF DESCRIPTION OF THE DRAWINGS

There is shown in the drawings embodiments which are presently preferred, it being understood, however, that the invention can be embodied in other forms without departing from the spirit or essential attributes thereof.

FIG. 1 is a stability chart for the delayed damped Mathieu Equation, shown in δ vs. ε parameter space, for b=0.01 and κ=0.05.

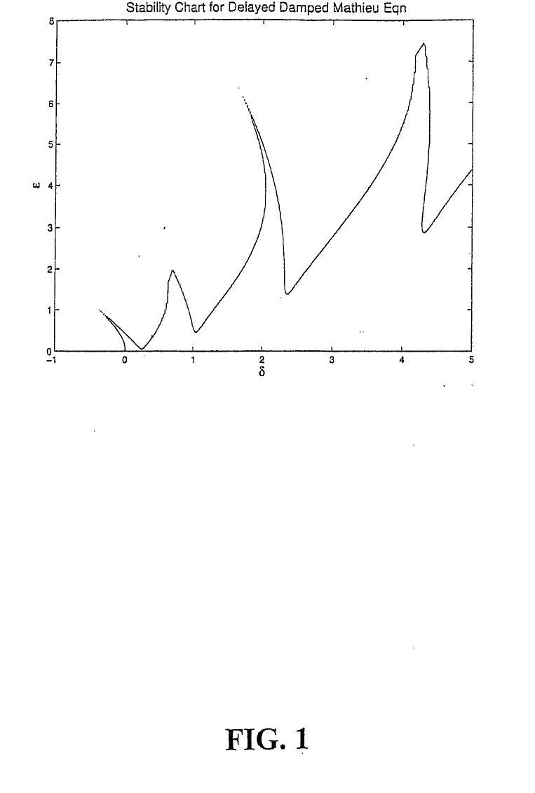

FIG. 2 shows the largest empirical and semi-analytical characteristic multiplier that have been estimated as a function of κ=0.05, δ=3, and b=0.01.

FIG. 3 shows a schematic of an interrupted turning operation and a perturbation being applied to the steady-state motions of the tool.

FIG. 4 shows an interrupted turning stability chart for known parameter values (dotted line) and estimated parameter values (solid line).

FIG. 5 shows an exemplary cutting test where two regions of transient motion are utilized for parameter estimation. Flexure oscillations are measured during a cutting test performed at b=2.9 [mm], h=0.1016 [mm/rev], and Ω=3810 [rpm].

FIG. 6 shows a single degree of freedom milling system which provides an experimental system with time delays due to self-excited vibrations.

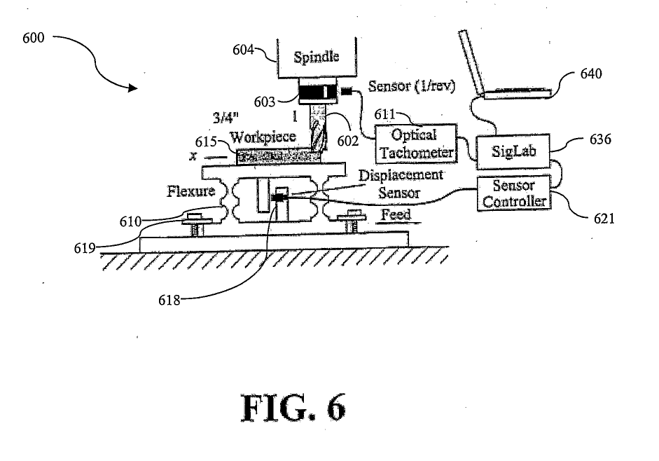

FIG. 7 shows up-milling stability boundaries vs. experimental results. The symbols in FIG. 7 as follows: a) is a clearly stable case; b) is an unstable cutting test; and c) is a borderline unstable case (i.e. not clearly stable or unstable).

FIG. 8 shows experimental up-milling measurement data for cases (A, B, C, D) shown in FIG. 8. Each row contains a x-axis 1/tooth displacement plot, a Poincaré section shown in displacement (xₙ) vs. delayed displacement (xₙ₂) coordinates, and the tooth passing frequency is marked by ∘ on the power spectrum (PSD). Unstable cutting processes are shown in cases A(Ω=3050 [rpm], b=2.7 [mm]), B(Ω=3565 [rpm], b=2.1 [mm]), and C(Ω=3635 [rpm], b=2.0 [mm]) and case D(Ω=3810 [rpm], b=2.9 [mm]) is a stable process. Cases A and B result from unstable Neimark-Sacker or secondary Hopf bifurcations and case C shows a flip bifurcation.

### DETAILED DESCRIPTION

The invention describes a method for determining cutting process model parameters and modal parameters for the cutting tool directly from measured vibratory motions generated by the cutting process. Vibration data can be obtained directly from vibration sensors, or using data from displacement, velocity or acceleration sensors. No other external excitation is required. Preferably, vibration and related measurements are obtained from transient motions at the beginning of the cut or at a location of an induced perturbation to extract characteristic multipliers (eigenvalues) for the cutting tool/workpiece system. The experimentally obtained eigenvalues are generally compared with analytical methods and/or various different models to determine the model parameters to be used for cutting.

Math model parameters are preferably obtained from two portions of a cutting test. Parameters describing the structural model can be estimated from the transients vibrations at the end of a cutting process. Thus, the invention removes the need for an additional step, such as the methods of parameter estimation described in the background. The final terms required for the prediction of stability, accuracy (surface location error), and surface quality is the coupling of the cutting forces with the intertial terms. This approach uses either an induced transient (during cutting) or the transient motions at the beginning of a cut to estimate these parameter(s). Accordingly, the invention will enable improved decision making information (stability, accuracy, and surface quality) and as a result the improve productivity, efficiency, and accuracy of the cutting process.

The tool/tool holder/spindle-workpiece system and process for determining cutting parameters according to the invention is preferably modeled as a time-delayed dynamic system. An empirical method is used for determining the truncated system characteristic multipliers. Characteristic multipliers (eigenvalues) can be accurately obtained for both numerical data (when parameters are know a priori) or a generally more useful approach is to directly determine the parameters from experimental data. The technique differs from previous disclosed work on systems without delays, since when delays are included the dimension of the phase space, or truncated dimension in this case, is not know a priori.

Empirical estimates for the system characteristic multipliers are obtained using either perturbations in the steady-state motion or the initial transients of the system, such as in the case of the experimental milling system. Characteristic multiplier estimates can be compared with the results of a semi-analytical approach to perform parameter identification for the cutting process. The presented results are applicable to a wide variety of systems with time delays. The invention enables parameter estimation and stability predictions to be performed from a single measurement of a trial cutting tests for machining processes, including turning and milling.

Systems governed by delay differential equations are relevant to many fields of science and engineering. The qualitative investigation of these dynamic systems often includes a stability analysis. Compact representations of the stable and unstable parameter domains are often presented in the form of stability charts.

Recent approaches for examining the stability behavior of time-delayed systems have shown it is possible to ascertain the stability characteristics of the resulting infinite dimensional system from a finite dimensional phase space. A common goal in these analyses is to transform the original set of equations into the form of a dynamic map that maps the system behavior over a single time delay. However, it is potentially useful to determine the stability behavior solely from experimental or numerical data.

Using the invention, empirical methods are described for determining the truncated system characteristic multipliers. As noted above, this differs from previous research focused on systems without delays since the dimension of the phase space, or truncated dimension in this case, is not know a priori. Empirical estimates for the system characteristic multipliers can be obtained using two different methods:

1) a perturbation, such as a force perturbation, a change in spindle speed, or a change in feed rate, is applied to the steady-state motion and the stability of the underlying behavior is inferred from the resulting transient; or

2) the experimentally measurements initial transients from the experimental milling system is analyzed. Characteristic multiplier estimates can be compared with the results of a semi-analytical approach based upon temporal finite element analysis for the purpose of parameter identification. While the methods described herein are applicable to a wide variety of systems with time delays, the ability to identify unknown machining processes parameters in the manner present will enable new possibilities. For instance, it is now possible to create stability lobes on-the-fly for a particular machine/tool/spindle. The stability lobes for any new tool put into service could then be estimated from a single cutting test. Additionally, one could monitor the cutting process and estimate the state of wear of a cutting tool (from changes in the estimated characteristic multipliers) as the forces increased/decreased with tool edge radius. Another possibility is recalibration of the model parameters and predictions (stability, accuracy, and surface quality) for machines as the spindles wear in prolonged service. In other words, this could also be used a structuring health monitoring approach for spindles, cutting tool life, or detection of a chipped cutting tool.

Estimation of Characteristic Multipliers

Since it is generally difficult to provide real-time control, it is helpful in many applications to consider the influence of a time delay on the system stability. The delayed damped Mathieu Equation, which has been the focus of several recent works, is considered to be a representative system with both delayed feedback and parametric excitation. The expression for the delayed damped Mathieu Equation is as follows:
\ddot{x}(t)+κ\dot{x}(t)+(δ+ε cos t)x(t)=bx(t−τ). (1)

The stability of this system can be investigated using a semi-analytical technique which transforms equation (1) into a discrete dynamical system. This results in a mapping solution over a single time delay and the system stability can be determined directly from the dynamic map characteristic multipliers. An empirical approach, which applies a single perturbation during numerical simulation, is then applied to estimate the reduced order dynamics and corresponding characteristic multipliers.

Dynamic Map Formulation

A semi-analytical approach for investigating the stability of the delayed damped Mathieu Equation is now described. The system is examined over a single period, where the period for the system corresponds to the time delay (τ), by dividing the time period into a finite number of elements. The motion of the system is approximated as a linear combination of polynomials within each element

$$x ( t ) = {\sum }_{i = 1}^{4} {a}_{i}^{n} {ϕ}_{i} ( σ ( t ) ) . \qquad ( 2 )$$

The trial functions or polynomials (φᵢ(σ(t))), which are given by equations (41)-(44) in the Appendix, are written as a function of the local time (σ(t)), which varies from zero to the time for each element (tⱼ), within each element of the n^{th} period. Substitution of the assumed solution (Equation 2) into the variational equation for the system leads to a non-zero error. The error from the assumed solution is weighted by multiplying by a set of test functions and setting the result of the integrated weighted error to zero. This provides two equations per element, which are given by:

$${\int }_{0}^{{t}_{j}} [ ( {\sum }_{i = 1}^{4} {a}_{ji}^{n} {\ddot{ϕ}}_{i} ( σ ) ) + κ ( {\sum }_{i = 1}^{4} {a}_{ji}^{n} {\dot{ϕ}}_{i} ( σ ) ) + ( δ + ɛ cos ( σ ) ) ( {\sum }_{i = 1}^{4} {a}_{ji}^{n} {ϕ}_{i} ( σ ) ) - b ( {\sum }_{i = 1}^{4} {a}_{ji}^{n - 1} {ϕ}_{i} ( σ ) ) ] {ψ}_{p} ( σ ) ⅆ σ = 0 , \\ p = 1 , 2 , \qquad ( 3 )$$

where the integration time for each element is tⱼ. It is noted that the equations for each element are linear in the coefficients of the assumed solution. Combining the resulting equations for each element, a global matrix equation can be obtained that relates the states of the system in the current period to the states of the system in the previous period

$${[ \begin{matrix}1 & 0 & 0 & 0 & 0 & 0 \\ 0 & 1 & 0 & 0 & 0 & 0 \\ {N}_{11}^{1} & {N}_{12}^{1} & {N}_{13}^{1} & {N}_{14}^{1} & 0 & 0 \\ {N}_{21}^{1} & {N}_{22}^{1} & {N}_{23}^{1} & {N}_{24}^{1} & 0 & 0 \\ 0 & 0 & {N}_{11}^{2} & {N}_{12}^{2} & {N}_{13}^{2} & {N}_{14}^{2} \\ 0 & 0 & {N}_{21}^{2} & {N}_{22}^{2} & {N}_{23}^{2} & {N}_{24}^{2}\end{matrix} ] [ \begin{matrix}{a}_{11} \\ {a}_{12} \\ {a}_{21} \\ {a}_{22} \\ {a}_{23} \\ {a}_{24}\end{matrix} ]}^{n} = {[ \begin{matrix}0 & 0 & 0 & 0 & 1 & 0 \\ 0 & 0 & 0 & 0 & 0 & 1 \\ {P}_{11}^{1} & {P}_{12}^{1} & {P}_{13}^{1} & {P}_{14}^{1} & 0 & 0 \\ {P}_{21}^{1} & {P}_{22}^{1} & {P}_{23}^{1} & {P}_{24}^{1} & 0 & 0 \\ 0 & 0 & {P}_{11}^{2} & {P}_{12}^{2} & {P}_{13}^{2} & {P}_{14}^{2} \\ 0 & 0 & {P}_{21}^{2} & {P}_{22}^{2} & {P}_{23}^{2} & {P}_{24}^{2}\end{matrix} ] [ \begin{matrix}{a}_{11} \\ {a}_{12} \\ {a}_{21} \\ {a}_{22} \\ {a}_{23} \\ {a}_{24}\end{matrix} ]}^{n - 1} , \qquad ( 4 )$$

where the above matrices are written for two elements and the terms inside the are given by:

$$\begin{matrix}{N}_{pi}^{j} = {\int }_{0}^{{t}_{j}} [ {\ddot{ϕ}}_{i} ( σ ) + κ {\dot{ϕ}}_{i} ( σ ) + [ δ + ɛ cos ( σ + {σ}_{j} ) ] {ϕ}_{i} ( σ ) ] {ψ}_{p} ( σ ) ⅆ σ , & ( 5 ) \\ {P}_{pi}^{j} = {\int }_{0}^{{t}_{j}} b {ϕ}_{i} ( σ ) {ψ}_{p} ( σ ) ⅆ σ & ( 6 )\end{matrix}$$

here σⱼ is a different constant for each element and takes on a value equivalent to the total time; this is done to maintain continuity of parametric excitation term. Equation (4) can be written in more compact form, or in the form of a discrete system dynamic map:
aₙ₊₁=Qaₙ. (7)

The stability of the system can then be determined directly from the monodromy operator (Q), which provides a mapping over a single time delay. If any transition matrix eigenvalue, which are also referred to as the characteristic multipliers for the dynamic map, have a magnitude greater than one, the system is considered unstable.

An Empirical Technique

An empirical approach can be applied to experimental or numerical data to determine stability. Characteristic multiplier estimates are obtained by applying a single perturbation during numerical simulation. A general nonlinear system is first considered that can be written as a dynamic map:
xₙ₊₁=g(xₙ). (8)
where xₙ and xₙ₊₁ are d×1 state vectors. Expanding the nonlinear terms on the right side about a fixed point solution (x_{f}) results in:
xₙ₊₁=x^{f}+P(xₙ−x_{f}) (9)
where P is a d×d Jacobian matrix. Collecting periodic samples of the transient motion, at the frequency of the time delay, results in a Poincaré section. Successive periodic samples provide a Poincaré map which can be written as m Poincaré mappings:
U=PV, (10)
where the matrices U and V are of dimension d×m and the elements of these matrices are given by
U=[x₁ x₂ . . . xₘ₊₁]−x_{f}, and V=[x₀ x₁ . . . xₘ]−x_{f}. (11)

The matrix P can be found directly from equation (10) once a sufficient number of Poincaré points have been recorded (i.e. m=d satisfies the uniqueness criteria). However, better estimates are obtained for the over constrained case (m>d) and the expression for P can be found in a least-squares sense
P=(VV^{T})⁻¹UV^{T}. (12)

The explanation for this improved result is that the least-squares approach provides a reduction in either experimental noise or numerical imprecision.

The correct choice for the truncated system dimension has yet to be discussed. Once the choice for the state vector dimension has been obtained, the empirical approach can be compared to the semi-analytical method. For instance, the eigenvalues of P can be compared to the characteristic multipliers of equation (7) using:
|P−μI|=0 (13)
which will result in a characteristic equation of order d. The paragraphs below discuss methods employed to obtain the correct reduced order model.
Reduced Order Dynamics

Two matters remain to be defined at this point. The first matter is the proper choice of the state space vector dimension. The second matter is the correct choice for the additional states of the system since only a single position state is likely to be available in an experiment and one additional velocity state would be available from numerical data.

One possibility for answering both matters is to use delayed embedding techniques and standard methods for dimension estimation from nonlinear time series analysis. For instance, a pseudo-phase space, which is considered topologically equivalent to the original phase space, can be reconstructed from a single measurement. This can be accomplished by finding a suitable time lag in the data and reconstructing the pseudo phase space via delayed reconstruction techniques. However, the short time duration of the transient makes it difficult to approximate both the proper choice for time lag and a suitable choice for the system dimension.

A second argument for choosing the additional state vectors can be made from the semi-analytical temporal finite element formulation. The use of the interpolated Hermite polynomials makes the coefficients of the assumed solution represent the velocity and displacement at evenly spaced points along the interval of the time delay. The final question of obtaining a proper lower-dimensional representation of the higher-dimensional data will be investigated via signal analysis methods. Two methods which can be applied to examine the experimental data include: 1) the rank of matrices; 2) singular value decomposition which has also been referred to as Proper Orthogonal Decomposition, Principal Component Analysis, or the Karhunen-Loeve Decomposition.

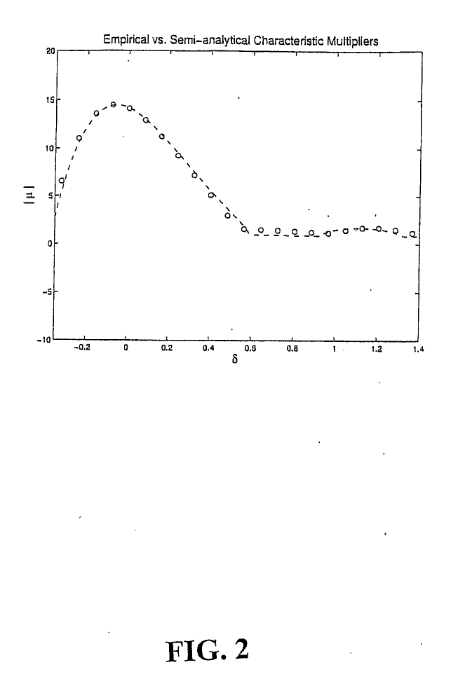

The first approach for choosing the system dimension included embedding the d-dimensional state vector with equally spaced displacement data over the time interval τ. Poincaré points were collected over m periods, where m was taken to be much larger than d, and the rank of the VV^{T} matrix was computed while increasing the dimension of the state vector. The proper choice for the system dimension was taken to be the at the point where the rank of the matrix stopped growing with and increase in the assumed system dimension. The largest characteristic multiplier value estimates from the empirical approach are compared to those obtained with the previously presented semi-analytical approach in FIG. 2.

The second approach used for choosing the system dimension also embedded the d-dimensional state vector with equally spaced displacement data over the same time interval. Poincaré points were collected over m periods, where m was taken to be much larger than d, and singular value decomposition of the VV^{T} matrix was computed while increasing the dimension of the state vector. The proper choice for the truncated system dimension was taken to be the at the point where a leveling off in the magnitude of the singular values occurred. It is noted that the rank of the matrices worked well for both numerical cases presented in this paper, but failed in the case of the experiment due to experimental noise. Therefore, the singular value approach was used for choosing the system dimension in the presences of experimental noise.

Parameter Estimation for Stability Prediction

Machining operations, such as cutting or milling, are a common example where a time delay in the system can result in instability. For instance, the relative vibratory motion between a cutting tool and workpiece can result in a machining process with time-varying chip loads. Since cutting forces are known to be approximately proportional to the uncut chip area, chip load variations cause dynamic cutting forces which may excite the structural modes of a machine-tool system resulting in unstable oscillations. Unless avoided, these unstable parameter domains may cause large dynamic loads on the machine, damage to the cutting tool, and a poor surface finish. The paragraphs below describe using numerical data from simulations of an interrupted turning operation to estimate characteristic multipliers and identify a commonly unknown parameter relation.

Interrupted Turning

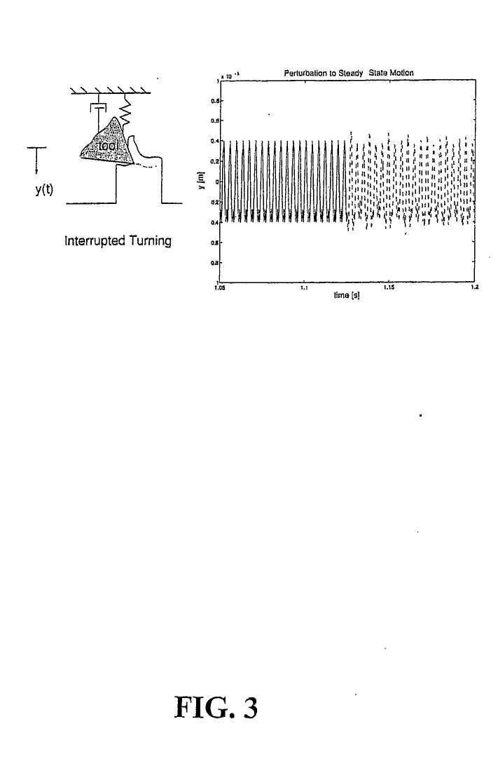

FIG. 3 shows a non-smooth dynamical system known as interrupted turning. The turning process is considered to have a rigid workpiece and a cutting tool compliant only in the y-direction. The equations of motion for this system can be written as:

$$\ddot{y} ( t ) + 2 ζ ω \dot{y} ( t ) + {ω}^{2} y ( t ) = - u ( t ) \frac{{K}_{s} b}{{m}_{o}} [ {h}_{o} + y ( t ) - y ( t - τ ) ] , \qquad ( 14 )$$

where ζ is the damping ratio, ω is the tool natural frequency, mₒ is the modal mass, u(t) is a square wave function to account for interrupted cutting, Kₛ is a cutting pressure coefficient, b is the depth of cut, and hₒ is the tool feed per workpiece revolution. The tooth passing period, or time delay between subsequent tooth passages, is given by τ=60/Ω[s] with Ω given in [rpm]. Equation (14) can be rewritten as
ÿ(t)+2ζω\dot{y}(t)+ω²y(t)=−u(t)bΓ[hₒ+y(t)−y(t−τ)], (15)
where Γ=Kₛ/mₒ has been substituted to reduce the number of parameters. The stability of equation (15) is examined by adding a perturbation, written as ξ(t), about a periodic solution yₚ(t)
y=yₚ(t)+ξ(t). (16)

This equation can be substituted into equation (15) to obtain
ÿₚ(t)+\ddot{ξ}(t)+2ζω\dot{ξ}(t)++2ζωyₚ(t)+ω²yₚ(t)+ω²ξ(t)=−u(t)bΓ[hₒ+ξ(t)−ξ(t−τ)]. (17)

The periodic solution, which reduces to the following equation
ÿₚ(t)+2ζωyₚ(t)+ω²yₚ(t)=−u(t)bΓh, (18)
can now be subtracted from equation (17) to obtain an equation strictly in terms of the perturbed motion. The variational equation for the perturbed motion becomes
\ddot{ξ}(t)+2ζω\dot{ξ}(t)+ω²ξ(t)=−u(t)bΓ[ξ(t)−ξ(t−τ)]. (19)

While perturbation growth results in an unstable solution, perturbation decay will result in an asymptotically stable solution. In the next section, we consider a semi-analytical approach to form matrices that transform equation (19) into a dynamic map.

Dynamic Map Formulation

A semi-analytical approach is now described for investigating the stability of the variational system described by equation (19). The approach examines a single revolution of the turning process by first establishing the relationship for free vibration. When the tool is not in contact with the workpiece, the system experiences free vibration and has the solution x(t)=c₁e^{λ}^{₁}^{t}+c₂e^{λ}^{₂}^{t}, where the characteristic exponents are λ_{1,2}=−ζω±ω\sqrt{ζ²−1}. If we let t_{f} be the duration of free vibration, a state transition matrix can be obtained that relates the state of the tool at the beginning of free vibration to the state of the tool as it reenters into the cut

$$[ \begin{matrix}x ( {t}_{f} ) \\ \dot{x} ( {t}_{f} )\end{matrix} ] = \frac{1}{{λ}_{1} - {λ}_{2}} ( \begin{matrix} {λ}_{1} {ⅇ}^{{λ}_{2} {t}_{f}} - {λ}_{2} {ⅇ}^{{λ}_{1} {t}_{f}} & {ⅇ}^{{λ}_{1} {t}_{f}} - {ⅇ}^{{λ}_{2} {t}_{f}} \\ {λ}_{1} {λ}_{2} {ⅇ}^{{λ}_{2} {t}_{f}} - {λ}_{1} {λ}_{2} {ⅇ}^{{λ}_{1} {t}_{f}} & {λ}_{1} {ⅇ}^{{λ}_{1} {t}_{f}} - {λ}_{2} {ⅇ}^{{λ}_{2} {t}_{f}}\end{matrix} ) [ \begin{matrix}x ( 0 ) \\ \dot{x} ( 0 )\end{matrix} ] . \qquad ( 20 )$$

This equation is true for every tooth passage period, such that for all n

$$[ \begin{matrix}x ( n τ ) \\ \dot{x} ( n τ )\end{matrix} ] = [ \begin{matrix}{Φ}_{11} {Φ}_{12} \\ {Φ}_{21} {Φ}_{22}\end{matrix} ] [ \begin{matrix}x ( ( n - 1 ) τ + {t}_{c} ) \\ \dot{x} ( ( n - 1 ) τ + {t}_{c} )\end{matrix} ] , \qquad ( 21 )$$

where Φ₁₁, Φ₁₂, Φ₂₁, and Φ₂₂ are the terms inside the 2×2 matrix of equation (20). The cutting motions are examined by dividing the period of the time delay into a finite number of elements to approximate the perturbed motion for the system, within each element, as a linear combination of polynomials

$$ξ ( t ) = {\sum }_{i = 1}^{4} {a}_{i}^{n} {ϕ}_{i} ( σ ( t ) ) . \qquad ( 22 )$$

Here the trial functions are still cubic Hermite polynomials. Substitution of the assumed solution (Equation 22) into the variational equation for the system leads to a non-zero error. The error from the assumed solution is weighted by multiplying by a set of weighting functions and setting the result of the integrated weighted error to zero. This provides two equations per element, which are given by:

$${\int }_{0}^{{t}_{j}} [ ( {\sum }_{i = 1}^{4} {a}_{ji}^{n} {\ddot{ϕ}}_{i} ( σ ) ) + 2 ζ ( {\sum }_{i = 1}^{4} {a}_{ji}^{n} {\dot{ϕ}}_{i} ( σ ) ) + ( 1 + b Γ ) ( {\sum }_{i = 1}^{4} {a}_{ji}^{n} {ϕ}_{i} ( σ ) ) - b Γ ( {\sum }_{i = 1}^{4} {a}_{ji}^{n - 1} {ϕ}_{i} ( σ ) ) ] {ψ}_{p} ( σ ) ⅆ σ = 0 , \\ p = 1 , 2 , \qquad ( 23 )$$

where the integration time for each element is tⱼ. It is noted that the equations for each element are linear in the coefficients of the assumed solution. Combining the resulting equations for each element, a global matrix equation can be obtained that relates the states of the perturbed motions in the current period to the states of the perturbed motions in the previous period:

$${[ \begin{matrix}1 & 0 & 0 & 0 & 0 & 0 \\ 0 & 1 & 0 & 0 & 0 & 0 \\ {N}_{11} & {N}_{12} & {N}_{13} & {N}_{14} & 0 & 0 \\ {N}_{21} & {N}_{22} & {N}_{23} & {N}_{24} & 0 & 0 \\ 0 & 0 & {N}_{11} & {N}_{12} & {N}_{13} & {N}_{14} \\ 0 & 0 & {N}_{21} & {N}_{22} & {N}_{23} & {N}_{24}\end{matrix} ] [ \begin{matrix}{a}_{11} \\ {a}_{12} \\ {a}_{21} \\ {a}_{22} \\ {a}_{23} \\ {a}_{24}\end{matrix} ]}^{n} = {[ \begin{matrix}0 & 0 & 0 & 0 & {Φ}_{11} & {Φ}_{12} \\ 0 & 0 & 0 & 0 & {Φ}_{21} & {Φ}_{22} \\ {P}_{11} & {P}_{12} & {P}_{13} & {P}_{14} & 0 & 0 \\ {P}_{21} & {P}_{22} & {P}_{23} & {P}_{24} & 0 & 0 \\ 0 & 0 & {P}_{11} & {P}_{12} & {P}_{13} & {P}_{14} \\ 0 & 0 & {P}_{21} & {P}_{22} & {P}_{23} & {P}_{24}\end{matrix} ] [ \begin{matrix}{a}_{11} \\ {a}_{12} \\ {a}_{21} \\ {a}_{22} \\ {a}_{23} \\ {a}_{24}\end{matrix} ]}^{n - 1} , \qquad ( 24 )$$

where the above matrices are written for two elements and the undefined terms inside the above matrices are given by

$$\begin{matrix}{N}_{pi} = {\int }_{0}^{{t}_{j}} [ {\ddot{ϕ}}_{i} ( σ ) + 2 ζ {\dot{ϕ}}_{i} ( σ ) + ( ω + b Γ ) {ϕ}_{i} ( σ ) ] {ψ}_{p} ( σ ) ⅆ σ , & ( 25 ) \\ {P}_{pi} = {\int }_{0}^{{t}_{j}} {ϕ}_{i} ( σ ) {ψ}_{p} ( σ ) b Γ ⅆ σ . & ( 26 )\end{matrix}$$

Equation (24) can be written in more compact form, or in the form of a linear dynamic map:
aₙ₊₁=Qaₙ. (27)

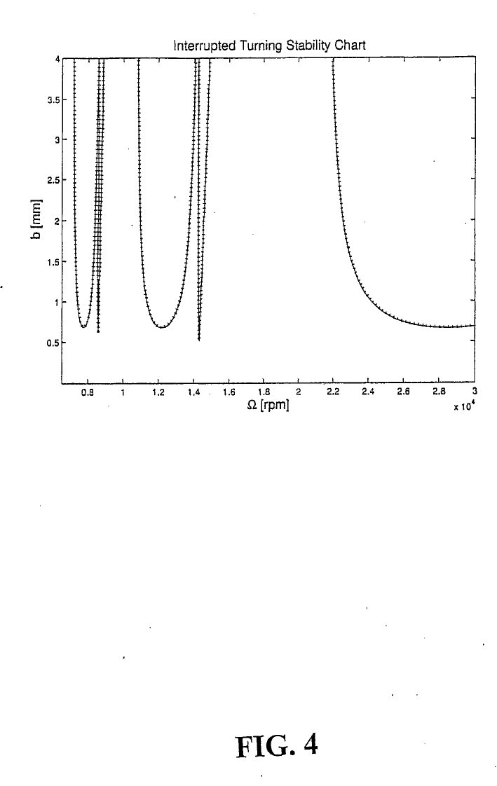

The stability of the system can be determined from the transition matrix (Q) that provides a mapping over the period of the time delay. If any of the transition matrix eigenvalues, commonly referred to as characteristic multipliers for the dynarnicmap, have a magnitude greater than one, the system is considered unstable. The example stability chart, shown in FIG. 4, uses the largest characteristic multiplier in establishing the transition between stable and unstable behavior.

Empirical Approach to Parameter Identification and Stability

The unknown parameters for the mechanical system are preferably estimated prior to applying the semi-analytical approach. For instance, a typical approach according to the invention is to use vibration tests to experimentally identify modal parameters for the system dynamic response. Separate cutting test are also commonly performed to estimate the directional cutting coefficient Kₛ which is specific to each tool geometry and material combination. This section illustrates how to directly identify certain model parameters by simply monitoring a single cutting tests. The predicted stability results are then compared for both the estimated model parameters and the known model parameters.

It is assumed that the system damping ratio, natural frequency, and fraction of the spindle period spent cutting are known parameters (ζ=0.0022, ω=2236.1 [rad/s], ρ=0.1). However, the remaining parameter (Γ), which has a known value of Γ3.33×10⁸ [N/Kgm²], is estimated for several spindle speeds (ω) and a single depth of cut (b=1 [mm]).

The numerical or experimental data required for parameter identification can also be obtained using the known parameters in a numerical simulation. The process begins by applying a perturbation during numerical simulation, as shown in FIG. 3, to provide data for empirical estimation of the system dimension and characteristic multipliers. The results for three different spindle speeds are shown in Table 1. As discussed in a previous section, the rank of the numerical data was used to obtain a two dimensional system with the characteristic multipliers μ₁ and μ₂ is listed in Table 1. The process of estimating an unknown parameter requires matching the empirical characteristic multipliers to the characteristic multipliers of equation (27). The difficulty in this approach is that the dimension of the semi-analytical approach to obtain a converged result is often higher than the lower dimensional space from the empirical approach. For instance, the semi-analytical approach gives the following characteristic equation for two elements
C₆μ⁶+C₅μ⁵+C₄μ⁴+C₃μ³+C₂μ²+C₁μ+C₀=0 (28)

where the corresponding coefficients for b=1 [mm] and Ω=16000 [rpm] are given in the

TABLE 1
Empirical characteristic multipliers and estimated system parameter

| ^{Ω}[rpm] | ^{b}[mm] | μ₁ | μ₂ | ^{Γ}[N/Kgm²] |
|---|---|---|---|---|
| 16000 | 1.0 | −0.5209 + 0.8036ⁱ | −0.5209 − 0.8036ⁱ | 3.335 × 10⁸ |
| 17000 | 1.0 | −0.6322 + 0.9541ⁱ | −0.6322 − 0.9541ⁱ | 3.319 × 10⁸ |
| 18000 | 1.0 | −0.3608 + 0.8901ⁱ | −0.3608 − 0.8901ⁱ | 3.430 × 10⁸ |

A lower dimensional version of the higher dimensional characteristic equation can be obtained by retaining the coefficients C₆, C₅, and C₄ and truncating the remaining coefficients of the lower-order terms. This can be justified because empirical estimates are only able to accurately identify a two characteristic multipliers or a second order characteristic equation. The values of Γ that solve the remaining characteristic equation are obtained with a root finding algorithm. The results from three different speeds are shown in Table 1. The corresponding stability regions, for both known and estimated parameters, are shown in FIG. 4.

### EXAMPLES

The present invention is further illustrated by the following specific simulation Examples, which should not be construed as limiting the scope or content of the invention in any way.

Study of Milling

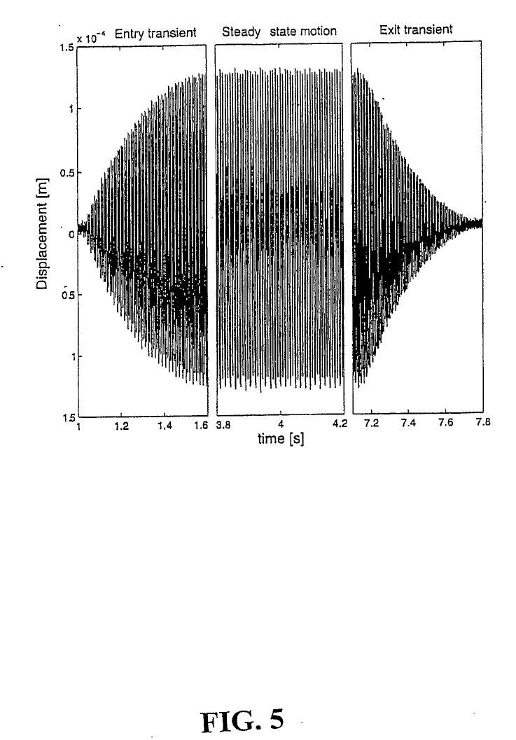

This section investigates empirical characteristic multiplier estimation, parameter identification, and stability prediction for an experimental milling system. The previously described methodology was implemented for an experiment that was designed to be a single degree of freedom. FIG. 5 shows an examplary cutting test where two regions of transient motion are utilized for parameter estimation. Instead of inducing a transient into the steady-state motion, the coupled cutter-workpiece transients at cutter entry are used for empirical characteristic multiplier estimation. The transient motion at the end of the cutting test—after the tool exits the cut—is used to estimate the system damping ratio (ζ) and natural frequency (ωₙ) via logarithmic decrement.

Milling Experimental Description

Experiments were performed on a flexure comprising system according to the invention 600 that was designed to be an order of magnitude more compliant than the cutting tool. Cutting tool included spindle 604/tool holder 603 and end mill 602. A periodic 1/tooth pulse was obtained with the use of a laser tachometer 611 to sense a black-white transition on the rotating tool holder 603. Workpiece 115 was disposed on a monolithic, unidirectional flexure 610 which was machined from aluminum and instrumented with a single non-contact, eddy current displacement sensor 618. Aluminum (7075-T6) test specimens 615, of width 6.35 [mm] and length 100 [mm], were mounted on the flexure 610 and milled with a single flute 19.050 [mm] diameter end mill 602. The compliant direction of flexure 610 was aligned with the tool feed direction during the cutting tests. Sensor controller 621 was connected to sensor 618.

Flexure 610 was affixed to a rigid surface using appropriate fasteners 619. In comparison to the compliant direction of each flexure 610, the values of stiffness in the perpendicular directions were more than 20 times greater, as was the stiffness of the tool. The displacement transducer output was anti-alias filtered and sampled (16-bit precision, 12800 samples/sec) with data acquisition hardware 636 connected to a laptop computer 640.

The spindle speed (Ω) and depth of cut (b) were changed for each cutting tests to determine the onset of unstable vibrations. Specimens were up-milled at a constant feed of 0.1016 [mm/rev] and a fraction of the spindle period in the cut of ρ=0.162.

Milling Process Model

For the specific case under consideration, the dynamics of the system can represented as a single degree of freedom model:

$$\ddot{x} ( t ) + 2 ζ ω \dot{x} ( t ) + ω x ( t ) = - \frac{{K}_{s} ( t )}{m} b [ x ( t ) - x ( t - τ ) ] - {f}_{o} ( t ) b , \qquad ( 29 )$$

where b is the axial depth of cut, h is the feed per tooth, and the terms of Kₛ(t) and fₒ(t) are compact notation for

$$\begin{matrix}{K}_{s} ( t ) = {\sum }_{p = 1}^{N} {g}_{p} ( t ) [ {K}_{t} cos {θ}_{p} ( t ) + {K}_{n} sin {θ}_{p} ( t ) ] sin {θ}_{p} ( t ) , & ( 30 ) \\ {f}_{o} ( t ) = {\sum }_{p = 1}^{N} {g}_{p} ( t ) [ {K}_{t} cos {θ}_{p} ( t ) + {K}_{n} sin {θ}_{p} ( t ) ] h sin {θ}_{p} ( t ) . & ( 31 )\end{matrix}$$

The terms Kₜ and Kₙ are cutting coefficients with units of pressure. A variational system can be formed writing the solution as a perturbation about the τ-periodic motion
x(t)=xₚ(t)+ξ(t), (32)
substituting equation (32) into equation (29), and subtraction off the equation for only periodic motion to obtain
\ddot{ξ}(t)+2ζω\dot{ξ}(t)+ω(t)=−K_{c}(t)b[ξ(t)−ξ(t−τ)]. (33)
Introducing a common approximation for Kₙ≈0.3Kₜ and dividing equation (30) by m results in:

$${K}_{c} ( t ) = {\sum }_{p = 1}^{N} {g}_{p} ( t ) [ {Γ}_{1} cos {θ}_{p} ( t ) + 0.3 {Γ}_{1} , sin {θ}_{p} ( t ) ] sin {θ}_{p} ( t ) , \qquad ( 34 )$$

where Γ₁=Kₜ/m. Following the same discretization method as shown for the turning problem, the dynamic map for milling is written using a single element:

$${[ \begin{matrix}1 & 0 & 0 & 0 \\ 0 & 1 & 0 & 0 \\ {N}_{11}^{1} & {N}_{12}^{1} & {N}_{13}^{1} & {N}_{14}^{1} \\ {N}_{21}^{1} & {N}_{22}^{1} & {N}_{23}^{1} & {N}_{24}^{1}\end{matrix} ] [ \begin{matrix}{a}_{11} \\ {a}_{12} \\ {a}_{13} \\ {a}_{14}\end{matrix} ]}^{n} = {[ \begin{matrix}0 & 0 & {Φ}_{11} & {Φ}_{12} \\ 0 & 0 & {Φ}_{21} & {Φ}_{22} \\ {P}_{11}^{1} & {P}_{12}^{1} & {P}_{13}^{1} & {P}_{14}^{1} \\ {P}_{21}^{1} & {P}_{22}^{1} & {P}_{23}^{1} & {P}_{24}^{1}\end{matrix} ] [ \begin{matrix}{a}_{11} \\ {a}_{12} \\ {a}_{13} \\ {a}_{14}\end{matrix} ]}^{n - 1} , \qquad ( 35 )$$

where Φ₁₁, Φ₁₂, Φ₂₁, and Φ₂₂ are the terms defined in equation (21) and the remaining above matrices are given by:

$$\begin{matrix}{N}_{pi} = {\int }_{0}^{{t}_{j}} [ {\ddot{ϕ}}_{i} ( σ ) + 2 ζ ω {\dot{ϕ}}_{i} ( σ ) + ( {ω}^{2} + b {K}_{c} ) ( σ ) ) {ϕ}_{i} ( σ ) ] {ψ}_{p} ( σ ) ⅆ σ , & ( 36 ) \\ {P}_{pi} = {\int }_{0}^{{t}_{j}} {bK}_{c} ( σ ) {ϕ}_{i} ( σ ) {ψ}_{p} ( σ ) ⅆ σ . & ( 37 )\end{matrix}$$

Experimental System Parameter Identification

A single cutting test, shown in FIG. 5, was used to estimate all of the required model parameters to predict the stability of the system. The damping ratio was estimated from the transient motion at the cutter exit with the following relationship:

$$ζ = \frac{ln ( {x}_{A} / {x}_{B} )}{\sqrt{{( 2 π )}^{2} + {ln ( {x}_{A} / {x}_{B} )}^{2}}} \approx 0.003 , \qquad ( 38 )$$

where x_{A} and x_{B} represent the motion amplitude for consecutive peaks of free vibration. The natural frequency for the system is estimated from the time period (T) between consecutive peaks as:

$$ω = \frac{2 π}{T \sqrt{1 - {ζ}^{2}}} \approx 920.5 [ rad \text{/} s ] . \qquad ( 39 )$$

Empirical characteristic multipliers were estimated from the entry transient of the cutting process (see FIG. 5); the necessary fixed-point measurements were taken from the steady-state portion of the signal. The following characteristic multipliers were obtained from the empirical approach μ₁=−0.6019+0.1312i, μ₂=−0.6019−0.1312i, μ₃=−0.2106. To ensure a converged result, a three element discretizaton was used to produce the following characteristic equation
C₈μ⁸+C₇μ⁷+C₆μ⁶+C₅μ⁵+C₄μ⁴+C₃μ³+C₂μ²+C₁μ+C₀=0 (40)
where the expressions for the coefficients are listed in appendix equation (46). The lower dimensional version of equation (40) is obtained by matching the coefficients C₈, C₇, C₆, and C₅ to the characteristic equation of the empirical characteristic multipliers; this gives the following estimate for the unknown parameter Γ₁=2.03×10⁸ [N/Kgm²].
Milling Results

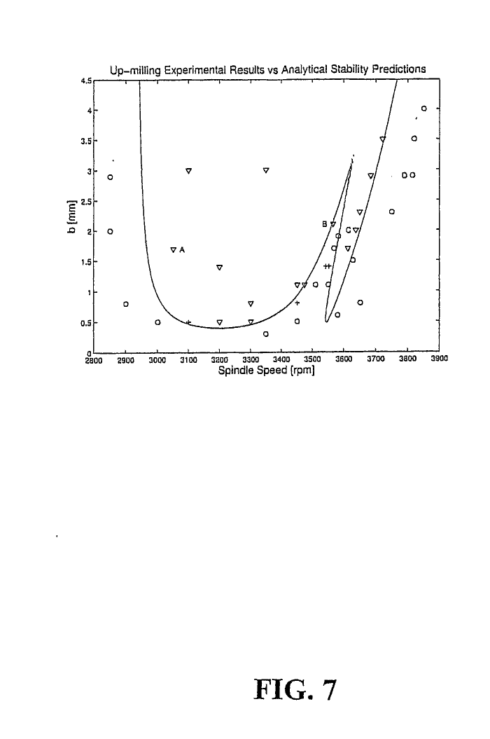

Experimental stability results have been superimposed onto stability predictions made using the estimated parameters from a single cutting tests (see FIG. 7). The results from the experimental cutting tests show strong agreement with the predicted results. Additionally, the stability predictions are nearly identical to those obtained when separate modal test and dynamometer cutting force measurements are used for parameter estimation.

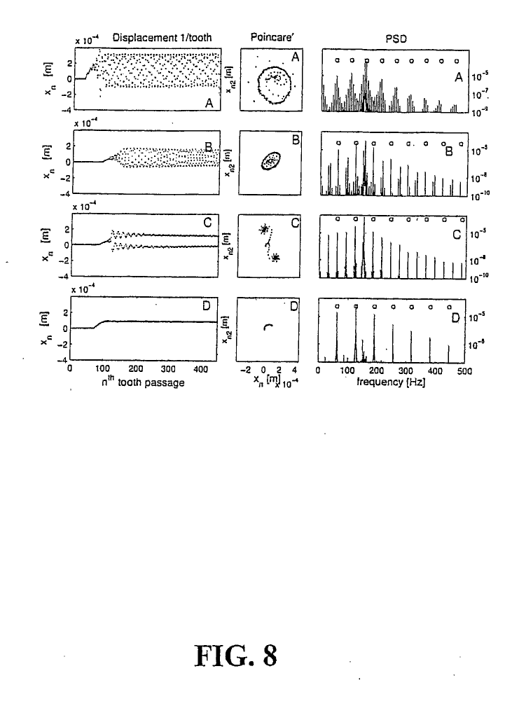

Raw displacement measurements were periodically sampled at the tooth passage frequency to create 1/tooth passage displacement samples and Poincaré sections shown in displacement vs. delayed displacement coordinates. These plots are also shown with the PSD (Power Spectral Density) of the continuously sampled displacement in FIG. 8. Tests were declared stable if the 1/tooth passage sampled displacement, or τ-periodic samples, approached a fixed point value (see FIG. 8, case D).

Unstable behavior predicted by complex characteristic multipliers with a magnitude greater than one, shown by case A and B, corresponds to Neimark-Sacker or secondary Hopf bifurcation. These post-bifurcation test results show the 1/tooth-passage displacement samples are incommensurate with the tooth passage frequency and quasiperiodic motions can be observed in the Poincaré sections.

Unstable period-doubling behavior, commonly referred to as a flip bifurcation, is predicted when the dominant characteristic multiplier of the dynamic map model is negative and real with a magnitude greater than one. Experimental evidence of this type of post-bifurcation behavior is shown by case C shown in FIG. 8.

This invention can be embodied in other forms without departing from the spirit or essential attributes thereof and, accordingly, reference should be had to the following claims rather than the foregoing specification as indicating the scope of the invention.

### APPENDIX

The following trial functions are the cubic Hermite polynomials used in the analysis described as the semi-analytical approach:

$$\begin{matrix}{ϕ}_{1} ( {σ}_{j} ) = 1 - 3 {( \frac{σ}{{t}_{j}} )}^{2} + 2 {( \frac{σ}{{t}_{j}} )}^{3} , & ( 41 ) \\ {ϕ}_{2} ( σ ) = {t}_{j} [ ( \frac{σ}{{t}_{j}} ) - 2 {( \frac{σ}{{t}_{j}} )}^{2} + {( \frac{σ}{{t}_{j}} )}^{3} ] , & ( 42 ) \\ {ϕ}_{3} ( σ ) = 3 {( \frac{σ}{{t}_{j}} )}^{2} - 2 {( \frac{σ}{{t}_{j}} )}^{3} , & ( 43 ) \\ {ϕ}_{4} ( σ ) = {t}_{j} [ - {( \frac{σ}{{t}_{j}} )}^{2} + {( \frac{σ}{{t}_{j}} )}^{3} ] . & ( 44 )\end{matrix}$$

The following characteristic equation is obtained for the interrupted turning case b=1 [mm] and Ω=16000 [rpm]
(7.023766624×10⁻²⁸Γ³+4.602090935×10⁻¹⁶Γ²+0.0001381332793Γ+7.543712843×10⁻⁴⁰Γ⁴+29177067.90)μ⁶+(3.159522336×10⁻²⁵Γ³−8.6989673194×10⁻⁴Γ²+0.004139126414Γ−2.528815503×10⁻³⁷Γ⁴+29012975.24)μ⁵+(1.730425391×10⁻¹³Γ²−0.004144205094Γ+1.004711825×10⁻³⁶Γ⁴−9.513931387×10⁻²⁵Γ³+28103202.25)μ⁴+(−0.0001330545988Γ−8.695689496×10⁻¹⁴Γ²+9.514422475×10⁻²⁵Γ³−1.505119221×10⁻³⁶Γ⁴)μ³+(−3.160258968×10⁻²⁵Γ³+4.438199718×10⁻¹⁶Γ²+1.004586649×10⁻³⁶Γ⁴)μ²+(−6.778222923×10⁻²⁸Γ³−2.527814097×10⁻³⁷Γ⁴)μ+7.293361256×10⁻⁴⁰Γ⁴=0. (45)

This equation is the characteristic equation for the case of milling b=2.9 [mm] and 3810 [rpm].
(0.3923488795Γ₁+5.672405864×10⁻¹¹Γ₁²+1868726060.0+4.125348217×10⁻²¹Γ₁³+2.189889140×10⁻³¹Γ₁⁴+5.106489813×10⁻⁴²Γ₁⁵+9.44513972×10⁻⁵³Γ₁⁶)λ⁸+(4.991035124×10⁻⁵¹Γ₁⁶+4.654631772×10⁻¹⁹Γ₁³+1185687787.0−2.401925053×10⁻⁴⁰Γ₁⁵−1.305023996×10⁻²⁹Γ₁⁴+6.344664438Γ₁−0.000000004037360008Γ₁²)λ⁷+(−3.192231245×10⁻⁵⁰Γ₁⁶+1.125899841×10⁻³⁹Γ₁⁵+5.011150986×10⁻²⁹Γ₁⁴−6.384624950Γ₁+0.000000007947223224Γ₁²+1703405380.0−1.418492245×10⁻¹⁸Γ₁³)λ⁶+(1.421444319×10⁻¹⁸Γ₁³+8.143286398×10⁻⁵⁰Γ₁⁶−2.205338927×10⁻³⁹Γ₁⁵7.432342490×10⁻²⁹Γ₁⁴−0.3523885929Γ₁−0.000000004009263110Γ₁²)λ⁵+(−1.096274600×10⁻⁴⁹Γ₁⁶+2.187480276×10⁻³⁹Γ₁⁵+4.267583331×10⁻¹¹Γ₁²+4.95187810×10⁻²⁹Γ₁⁴−4.698913573×10⁻¹⁹Γ₁³)λ⁴+(−1.257606073×10⁻²⁹Γ₁⁴−1.093754360×10⁻³⁹Γ₁⁵−2.649243446×10⁻²¹Γ₁³+8.265194203×10⁻⁵⁰Γ₁⁶)λ³+(1.004457219×10⁻³¹Γ₁⁴+2.223340164×10⁻⁴⁰Γ₁⁵−3.314139561×10⁻⁵⁰Γ₁⁶)λ²+(−1.534824748×10⁻⁴²Γ₁⁵+5.513502936×10⁻⁵¹Γ₁⁶)λ+7.372588631×10⁻⁵⁴Γ₁⁶ (46)

1. A method for directly determining model parameters for a machining process, comprising the steps of:
providing a system comprising a machining tool and a workpiece;
machining said workpiece using said machining tool, wherein said machining induces motions in said machining tool or said workpiece;
measuring said motions;
estimating system characteristic multipliers (eigenvalues) from said motions, and
relating said eigenvalues to results of at least one of an analytical method and theoretical model to obtain a set of process model parameters.

2. The method of claim 1, wherein said motions are induced exclusively by said machining step.

3. The method of claim 1, further comprising the step of using said model parameters to determine at least one of stability, surface location error and surface quality predictions.

4. The method of claim 1, wherein said analytical method comprises a semi-analytical approach.

5. The method of claim 1, wherein said motions are obtained from sensing acceleration, velocity or displacement of said workpiece.

6. The method of claim 1, wherein said motions are obtained during steady-state motion of said system.

7. The method of claim 1, wherein said vibrations are obtained during initial transients of said system.

8. The method of claim 1, wherein said model parameters of said machining tool are estimated directly from said motions at the end of said machining step.
